(19) United States
(12) Patent Application Publication
(10) Pub. No.: US 2016/0121407 A1
(43) Pub. Date: May 5, 2016

(54) INNER SLEEVE FOR TAPER COLLET AND CUTTING TOOL HOLDER

(71) Applicants: NATIONAL INSTITUTE OF TECHNOLOGY, Tokyo (JP); DAIDO STEEL CO., LTD., Nagoya-shi (JP)

(72) Inventors: Fumihito SAKURAI, Gunma (JP); Shin WATANABE, Aichi (JP); Eiichi TARUOKA, Aichi (JP)

(73) Assignees: NATIONAL INSTITUTE OF TECHNOLOGY, Tokyo (JP); DAIDO STEEL CO., LTD., Nagoya-shi (JP)

(21) Appl. No.: 14/923,969

(22) Filed: Oct. 27, 2015

(30) Foreign Application Priority Data
Oct. 29, 2014 (JP) 2014-220788

(51) Int. Cl. B23B 31/20

(52) U.S. Cl. CPC B23B 31/20; B23B 2231/2056; B23B 2231/2013; B23B 2250/16

(57) ABSTRACT

The present invention relates to an inner sleeve for a taper collet containing a cylindrical part containing a damping alloy having a slit provided thereon, and to a cutting tool holder containing a collet chuck body, a taper collet, and the inner sleeve for a taper collet

### FIELD OF THE INVENTION

The present invention relates to an inner sleeve used in a taper collet for fastening a cutting tool to a rotary cutting machine, and also relates to a cutting tool holder containing the same.

### BACKGROUND ART OF THE INVENTION

When continuation vibration, a so-called “chattering”, due to the contact between a cutting tool and a workpiece to be cut (hereinafter referred to as “chatter vibration”) is generated in cutting operation, machining accuracy of the workpiece to be cut is decreased, resulting in poor cutting. In order to deal with this problem, a proposal has been made to damp vibration by giving a member having a vibration-damping function, in addition to increasing rigidity of a chuck for fixing a cutting tool or a holder to be fastened thereto, thereby preventing generation of the vibration.

For example, PTL. 1 discloses a holder for a boring bar (holding tool) for mounting a boring bar used in inner diameter machining on a cutter holder of a lathe or the like, in which a member made of a damping alloy is inserted between the holder and the boring bar. The boring bar is fixed by inserting a shank part thereof into an inner hole of the holder and pushing the shank part to one side of the inner hole by a clamp screw. A plank member made of aluminum, copper, zinc, brass, or a damping steel plate is placed on the pushing surface to interpose between the shank part and the inner hole. Vibration generated in a cutting edge of a throw-away chip in cutting operation is dampened by the plank member having vibration-damping properties before propagating to the holder from the shank part of the boring bar, whereby vibration is prevented from directly transmitting to the holder and the boring bar is prevented from vibrating together with the holder.

In the case where a cutting tool such as an end mill is fitted to a cutting tool holder fastened to a chuck of the rotary cutting machine, a substantially cylindrical collet having cuts radially formed from a center is frequently used. Particularly, in the case of fitting a cutting tool having a relatively small diameter, a taper collet provided with a taper having a diameter increased toward a cutting tool side is frequently used such that large fastening size can be obtained in a chuck. Even in the case of using such a taper collet, it is required to prevent chatter vibration.

For example, PTL. 2 describes that in a cutting tool holder using a taper collet, the cutting tool holder expands by a centrifugal force of high speed rotation, fastening force of a fastening nut of the taper collet is decreased, and chatter vibration is easily generated. Then, PTL. 2 discloses that a biasing means such as a dish spring for biasing in a direction fastening the taper collet is provided in the inside of the fastening nut of the taper collet for increasing rigidity of the holder, the taper collet and the cutting tool.

Furthermore, PTL. 3 describes a prevention method of chatter vibration at high speed rotation in a cutting tool holder using a taper collet. PTL. 3 discloses that a taper collet is not fastened by a fastening nut from a cutting tool side, but a pull bolt connected to a draw bar is extended to a cutting tool side, and a tip of the taper collet is screwed with the pull bolt. The taper collet is strongly pulled in an inner circumferential taper part of a collet chuck body of the cutting tool holder by tensile force of the draw bar, whereby chatter vibration can be prevented.

PTL. 1: JP-UM-A-H05-088804

PTL. 2: JP-A-H07-276116

PTL. 3: JP-UM-A-H06-066901

### SUMMARY OF THE INVENTION

It is considered that also in a cutting tool holder using a taper collet, vibration is absorbed by giving a member having a damping function, in addition to preventing the generation of chatter vibration by enhancing rigidity of the holder. A damping alloy giving a damping function generally converts vibration into heat of internal friction and absorbs the heat, and therefore, rigidity thereof is not so high as compared with that of a tool steel or the like. Therefore, it is required to optimize a shape and arrangement of a member having a damping function made of the damping alloy so as to enhance machining accuracy of a workpiece to be cut.

The present invention has been made in view of the above circumstances, and the object thereof is to provide an inner sleeve which is used in a taper collet for fastening a cutting tool to a rotary cutting machine and capable of enhancing machining accuracy of a workpiece to be cut, and also to provide a cutting tool holder containing the same.

In order to achieve the object, the present invention provide an inner sleeve for a taper collet, which is to be inserted in a taper collet grasping a shank part of a cutting tool, containing a cylindrical part containing a damping alloy having a slit provided thereon.

According to the present invention, vibration generated in a cutting tool can be dampened by the cylindrical inner sleeve containing a damping alloy fitted to a fastening part of a taper collet, and as a result, chatter vibration can be prevented, machining accuracy of a workpiece to be cut is enhanced, and particularly surface roughness of a machined surface can be improved.

In the present invention, it is preferable that the slit include a first slit formed from a first end part in a longitudinal direction of the cylindrical part toward a second end part thereof so as not to penetrate therethrough, and a second slit formed from the second end part toward the first end part so as to not penetrate therethrough, in which the first slit and the second slit are alternately provided. According to this embodiment, vibration generated in a cutting tool can be dampened while maintaining reliable fastening of the cutting tool by a taper collet, machining accuracy of a workpiece to be cut can be enhanced, and particularly surface roughness of a machined surface can be improved.

In the present invention, it is preferable that each of the first slit and the second slit has a length larger than ½ of the length of the cylindrical part in a longitudinal direction. According to this embodiment, vibration generated in a cutting tool can be effectively dampened while maintaining reliable fastening of the cutting tool by a taper collet, machining accuracy of a workpiece to be cut can be enhanced, and particularly surface roughness of a machined surface can be improved.

In the present invention, it is preferable that the slit include a third slit penetrating from the first end part to the second end part. According to this embodiment, vibration generated in a cutting tool can be dampened while maintaining reliable fastening of the cutting tool by a taper collet, machining accuracy of a workpiece to be cut can be enhanced, and particularly surface roughness of a machined surface can be improved.

In the present invention, it is preferable that the inner sleeve further contains a locking section, which is to be engaged with the taper collet, on an end part in a longitudinal direction of the cylindrical part. According to this embodiment, positioning of the inner sleeve to the taper collet can be surely performed, a cutting tool can be surely grasped while maintaining reliable fastening of the cutting tool by the taper collet, vibration generated in the cutting tool can be dampened, machining accuracy of a workpiece to be cut is enhanced, and particularly surface roughness of a machined surface can be improved.

In the present invention, it is preferable that the taper collet contains a taper part and a ratio of a thickness of the cylindrical part at a central position in a longitudinal direction and a thickness at a central position in a longitudinal direction of the taper part is from 5:95 to 99:1. According to this embodiment, vibration generated in a cutting tool can be effectively dampened, machining accuracy of a workpiece to be cut can be enhanced, and particularly surface roughness of a machined surface can be improved.

Further, the present invention provides a cutting tool holder containing a collet chuck body, the taper collet, and the inner sleeve for a taper collet of the present invention.

According to the present invention, vibration generated in a cutting tool can be dampened while enhancing rigidity of the cutting tool holder, and as a result, chatter vibration can be prevented, machining accuracy of a workpiece to be cut can be enhanced, and particularly surface roughness of a machined surface can be improved.

### BRIEF DESCRIPTION OF THE DRAWINGS

FIG. 1 is a side cross-sectional view of a cutting tool holder according to the present invention.

FIG. 2 illustrates a taper collet used in a cutting tool holder, (a) is a side view, and (b) is a front view.

FIG. 3 illustrates an inner sleeve according to the present invention, (a) is a side view, and (b) is a front view.

FIG. 4 illustrates another inner sleeve according to the present invention, (a) is a side view, and (b) is a front view.

FIG. 5 is a view illustrating a cutting method in a cutting test.

FIG. 6A is a graph showing intensity of vibration acceleration in a cutting test.

FIG. 6B is a graph showing power of vibration acceleration in a cutting test.

FIG. 7A is a graph showing measurement results of surface roughness of Comparative Example in a cutting test.

FIG. 7B is a graph showing measurement results of surface roughness of Example in a cutting test.

### DETAILED DESCRIPTION OF THE INVENTION

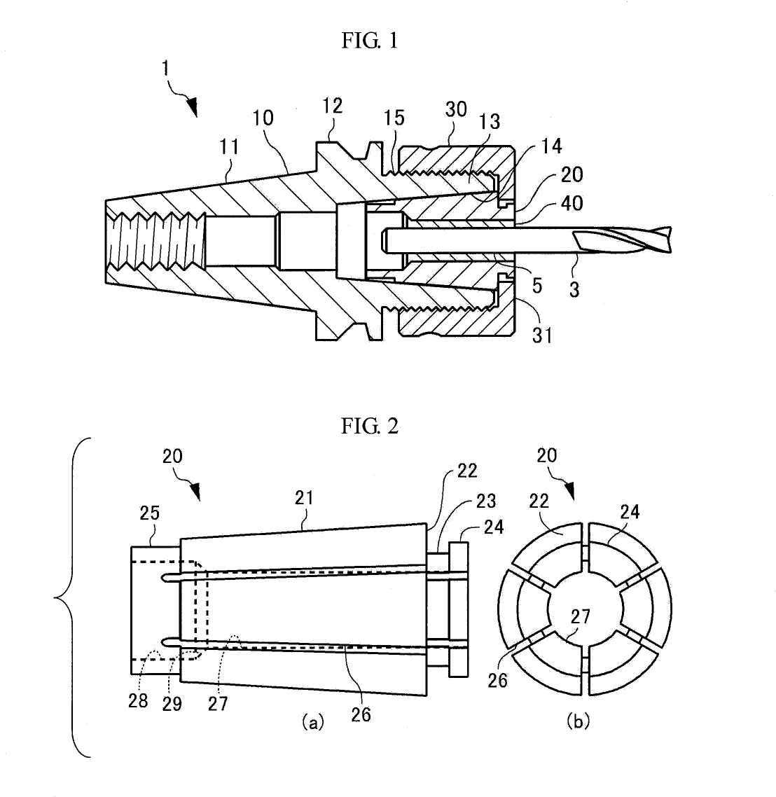

A cutting tool holder as one example according to the present invention is described hereinbelow with reference to FIG. 1 to FIG. 4.

As illustrated in FIG. 1, a cutting tool holder 1 includes a collet chuck body 10, a taper collet 20 to be inserted in a chuck cylinder 13 of the collet chuck body 10, and a nut 30 fixing so as to push the taper collet 20 into the chuck cylinder 13. A substantially cylindrical inner sleeve 40 is inserted in the inner circumference of the taper collet 20 to grasp a shank part 5 of a cutting tool 3.

The collet chuck body 10 has a shank part 11 at one end side mounted on a spindle of a machine tool not illustrated, and a flange part 12 between a chuck cylinder 13 at the other end side and the shank part. The chuck cylinder 13 has a taper 14 having a diameter increasing toward the other end side on its inner circumference, and has a screw screwing the nut 30 on the outer circumference. The nut 30 has a pressing part 31 protruding in the inner circumference side at the end surface of the other end side, and presses the taper collet 20 toward the one end side of the collet chuck body 10 by the pressing part 31 when being fastened to a screw 15. Accordingly, a taper part 21 (see FIG. 2) at an outer circumference side of the taper collet 20 is pushed against the taper 14 at an inner circumference side of the chuck cylinder 13, whereby the taper collet 20 receives compressive force decreasing a diameter.

Referring also to FIG. 2, the taper collet 20 includes a substantially cylindrical body having a taper part 21 on a central part in an axial direction. The taper collet 20 has a shoulder part 22 at a large diameter side of the taper part 21 in an axial direction, which is to be pressed by the pressing part 31 of the nut 30. The taper collet 20 is provided with a protrusion part 23 further extending in an axial direction from the end surface of the shoulder part 22, and is further provided with a flange 24 having a diameter smaller than that of the shoulder part 22 at the end part of the protrusion part 23. The taper collet 20 also has a parallel part 25 extending in an axial direction on an end surface at a small diameter side of the taper part 21. The taper collet 20 also has 6 slits 26 in a circumferential direction at equal intervals, each of which penetrates from the vicinity of the end part of the parallel part 25 at a taper part 21 side to the end surface of the flange 24. The slit 26 is a so-called slitting, and can decrease a diameter of the taper collet 20 when the taper part 21 is pushed against the taper 14 of the collet chuck body 10.

The taper collet 20 has an inner circumferential surface 27 on the inner circumferential side thereof, which has a shape along a column surface continuing from the end surface of the flange 24 side to the vicinity of an end part at the parallel part 25 side of the taper part 21, and also has a large diameter part 28 connected to the inner circumferential surface 27 through a step part 29, which extends to the end part of the parallel part 25. A material used in the taper collet 20 is not particularly limited, but use can be made of, for example, a high carbon chromium bearing steel, a carbon steel for machine construction, a chromium steel, or a chromium molybdenum steel.

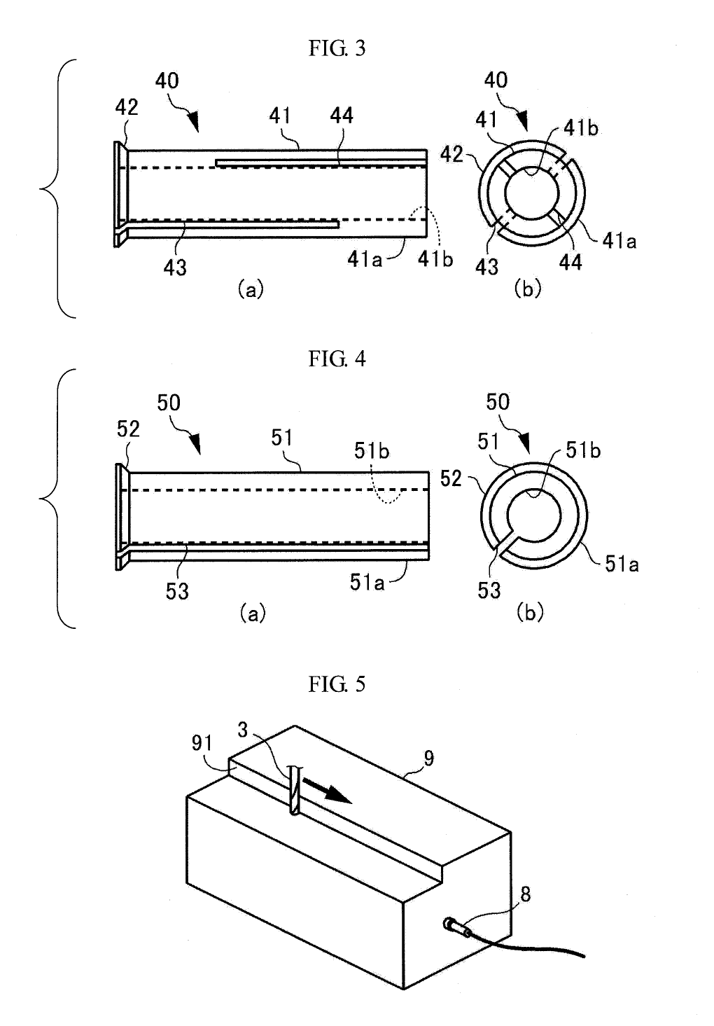

Furthermore, referring also to FIG. 3, the inner sleeve 40 to be inserted in an inner circumference of the taper collet 20 has a body part 41 formed of a substantially cylindrical body, and a flange part 42 which is to engage with the step part 29 (see FIG. 2) of the inner circumference of the taper collet 20 at one end part in an axial direction of the body part 41. The inner sleeve 40 inserted in the taper collet 20 is locked at a predetermined position by the flange part 42. The flange part 42 makes easy and secures the positioning of the inner sleeve 40 to the taper collet 20 in grasping the cutting tool 3, and therefore, the inner sleeve 40 can surely grasp the cutting tool 3 in a stable manner such that vibration generated in the cutting tool 3 grasped can be dampened.

The body part 41 has an outer circumferential surface 41 a which is brought into contact with the inner circumferential surface 27 of the taper collet 20, and an inner circumferential surface 41b as a grasp part grasping the shank part 5 of the cutting tool 3. The body part 41 further has a first slit 43 extending in an axial direction from an end part of the flange part 42 toward the other end part thereof. That is, the first slit 43 is provided so as not to penetrate over the other end part from the end part having the flange part 42. The body part 41 further has a second slit 44 extending in an axial direction toward the flange part 42 from the other end part. That is, the second slit 44 is provided so as not to penetrate over the end part having the flange part 42 from the other end part. The first slit 43 and the second slit 44 are formed larger than ½ of the length in an axial direction of the inner sleeve 40, and are alternately arranged in a circumferential direction at equal intervals. The length of the first slit 43 and that of the second slit 44 are independently preferably from 65% to 95%, and more preferably from 75% to 85% relative to the length in an axial direction of the inner sleeve 40. In this example, two first slits 43 and two second slits 44 are provided as four slits in total. By this, the inner sleeve 40 can uniformly and easily decrease the diameter in a radial direction when the outer circumferential surface 41 a is pressed by the inner circumferential surface 27 of the taper collet 20, and additionally can damp vibration generated in the cutting tool 3 grasped.

Considering rigidity and vibration absorption in the state of grasping the cutting tool 3 for damping vibration generated in the cutting tool 3, a ratio between a thickness at a center position in an axial direction of the inner sleeve 40 and a thickness at a center position in an axial direction of the taper part 21 of the taper collet 20 is preferably in a range of from 5:95 to 99:1, and more preferably from 15:85 to 40:60. Furthermore, from the standpoint of surely grasping the cutting tool 3, it is preferred that the inner sleeve 40 has a length in an axial direction, which comes into contact with the approximately entire length of the inner circumferential surface 27 of the taper collet 20.

According to the cutting tool holder 1 provided with the taper collet 20 and the inner sleeve 40 as described above, vibration generated in the cutting tool 3 can be dampened, and as a result, chatter vibration of the cutting tool 3 can be prevented, machining accuracy of a workpiece to be cut can be enhanced, and particularly surface roughness of a machined surface can be improved. The cutting tool holder 1 according to this example is particularly effective in a case where a relatively small cutting tool 3 is grasped, for example, in a case where an inner diameter of the taper collet 20 is 25 mm or less and a diameter of the shank part 5 is from 3 to 24.5 mm. Furthermore, abrasion loss of the cutting tool 3 can be reduced by suppressing vibration.

As illustrated in FIG. 4, an inner sleeve 50 having one slit can be used in place of the inner sleeve 40. The inner sleeve 50 has a body part 51 formed of a substantially cylindrical body, and a flange part 52 which is to engage with the step part 29 in the inner circumference of the taper collet 20 at one end part in an axial direction of the body part 51. The inner sleeve 50 inserted in the taper collet 20 is locked at a predetermined position by the flange part 52. The flange part 52 makes easy and secures the positioning of the inner sleeve 50 to the taper collet 20 in grasping the cutting tool 3, and therefore, the inner sleeve 50 can surely grasp the cutting tool 3 in a stable manner.

The body part 51 has an outer circumferential surface 51 a which is brought into contact with the inner circumferential surface 27 of the taper collet 20, and an inner circumferential surface 51b as a grasp part grasping the shank part 5 of the cutting tool 3. The body part 51 further has one slit 53 continuing from an end part at the flange part 52 to the other end part thereof. That is, the slit 53 penetrates over the other end part from the end part having the flange part 52, and the shape of the inner sleeve 50 is substantially C shape in a front view. By this, although the inner sleeve 50 has a shape which can be easily manufactured, the inner sleeve 50 uniformly and easily reduces the diameter in a radial direction when the outer circumferential surface 51 a is pressed by the inner circumferential surface 27 of the taper collet 20, thereby surely grasping the cutting tool 3, and can damp vibration generated in the cutting tool 3 grasped.

Similarly to the cutting tool holder 1 using the inner sleeve 40, the cutting tool holder 1 using the inner sleeve 50 can damp vibration generated in the cutting tool 3, and as a result, chatter vibration of the cutting tool 3 can be prevented, machining accuracy of a workpiece to be cut is enhanced, and particularly surface roughness of a machined surface can be improved.

As a damping alloy used in the inner sleeves 40 and 50, use can be made of a damping alloy which can deform itself by vibration thereof to convert vibration energy into thermal energy to absorb vibration. Examples thereof include an Fe—Cr-based damping alloy, an Fe—Al-based damping alloy and an Mn—Cu—Ni—Fe-based damping alloy. Of those, a twin-crystal type Mn—Cu—Ni—Fe-based damping alloy which has low rigidity and thus is easy to deform, and further has high damping function against vibration over a wide range of frequency can be preferably used.

Though it is not particularly limited, the Mn—Cu—Ni—Fe-based damping alloy preferably has a composition containing, in mass %, from 16.9% to 27.7% of Cu, from 2.1% to 8.2% of Ni, from 1.0% to 2.9% of Fe, and 0.05% or less of C, with the balance being Mn and unavoidable impurities. Here, composition ranges (mass % in each) of the respective components of the damping alloy will be briefly described. Regarding Cu, when the amount is 16.9% or more, twin crystals are easy to be formed, which is preferred. When the amount is 27.7% or less, segregation is prevented from becoming large and adequate vibration-damping properties are easy to obtain, which are preferred. More preferable composition range of Cu is from 19.7% to 25.0%. Regarding Ni, Ni is added as a third element together with Mn and Cu as main elements, and can improve vibration-damping properties. In order to efficiently exhibit such an effect, it is preferred that the composition range of Ni is 2.1% or more and 8.2% or less. Regarding Fe, Fe is added as a fourth element together with Mn, Cu and Ni, and can further improve vibration-damping properties. Preferably, when the amount of Fe is 1.0% or more, such an effect is easy to exhibited, and when the amount is 2.9% or less, the effect is not saturated, which are preferred. Regarding C, when the amount is 0.05% or less, deterioration of vibration-damping properties can be prevented even when the relative concentration of C has been increased by evaporation of Mn and the like.

An alloy having a young's modulus of from 60 to 90 GPa when measured by a dynamic viscoelastic measurement (DMA: Dynamic Mechanical Analysis) can be preferably used as the damping alloy, and one example thereof includes the above-described twin-crystal type Mn—Cu—Ni—Fe-based damping alloy.

Next, the results of a cutting test by the cutting tool holder 1 using the inner sleeve 40 having 4 slits are described with reference to FIG. 5 to FIG. 7B.

As illustrated in FIG. 5, a new end mill (manufactured by Mitsubishi Materials Co., Ltd.: 2MSD0600) having a blade diameter of 6 mm made of a cobalt high speed steel was mounted as the cutting tool 3 on a milling machine not illustrated by using the cutting tool holder 1. Then, shoulder milling by dry cutting was performed on a workpiece 9 formed of substantially rectangular hot dies steel (JIS G4404(2006)), vibration of the workpiece 9 during cutting was measured as acceleration by an acceleration pickup 8, and surface roughness was evaluated as machining accuracy of a cut surface 91. Furthermore, abrasion loss of the cutting tool 3 was measured.

The cutting tool 3 was mounted so as to protrude only 25 mm from the tip of the taper collet 20, and the length of the portion to be grasped was 25 mm that is a length in an axial direction of the body part 41 in the inner sleeve 40. As the cutting conditions, the number of revolution was set to 7,000 rpm, the cutting depth in 1-pass was set to 3.0 mm, the cutting width was set to 0.3 mm, the cutting feed speed was set to 700 mm/min, and the distance in 1-pass in a cutting feed direction was set to 160 mm, and the cutting was performed for each 100-pass.

The taper collet 20 used in the cutting test had an overall length of 45.0 mm, an inner diameter of the inner circumferential surface 27 of 8 mm, a length of the taper part 21 of 32.0 mm, and a thickness at a center position in an axial direction of the taper part 21 of about 7.2 mm. An Mn-based Mn—Cu—Ni—Fe-based damping alloy containing, in mass %, 22.4% of Cu, 5.2% of Ni, 2.0% of Fe, and 0.01% of C was used as the inner sleeve 40. The inner sleeve 40 had an overall length of 37 mm, an outer diameter of the body part 41 of 8.0 mm, and an inner diameter of 6.0 mm, and a thickness at a center position in an axial direction of 1 mm. That is, a ratio of the thickness at a center position in an axial direction of the inner sleeve 40 to the thickness at a center position in an axial direction of the taper part 21 of the taper collet 20 was about 12:88.

In the cutting test, other than the Example using the inner sleeve 40, the same test was performed in the Comparative Example in which the cutting tool 3 was directly grasped to the taper collet without using an inner sleeve. That is, in the Comparative Example, a taper collet having an inner diameter of an inner circumference surface of 6 mm was used.

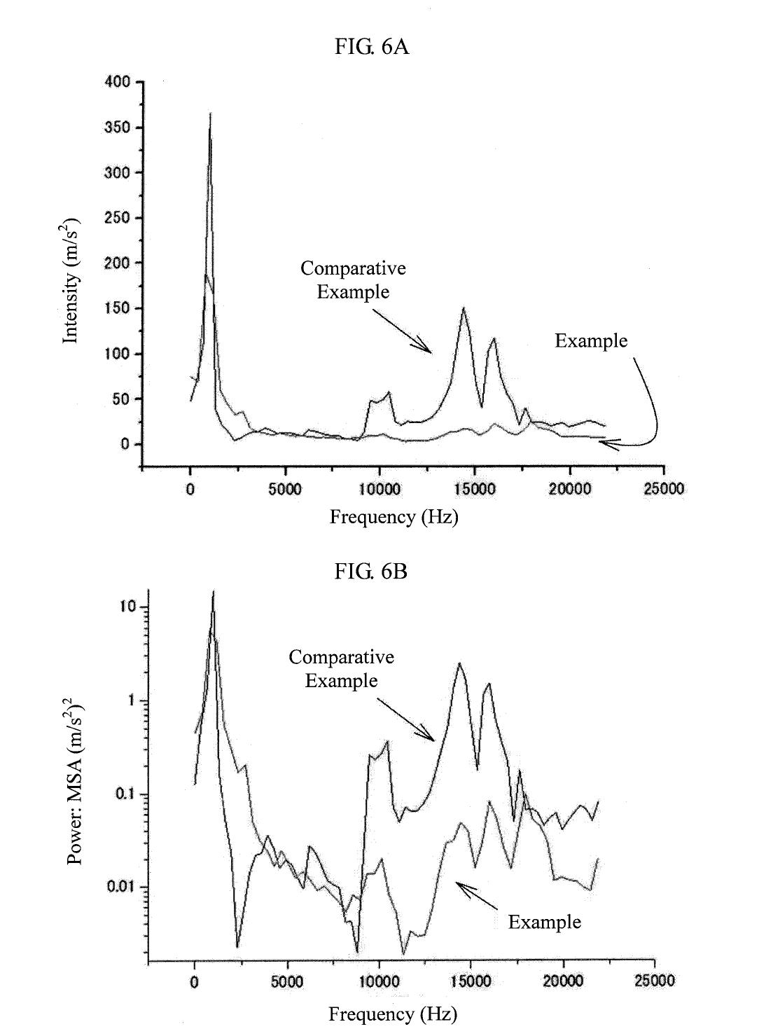

Regarding the measurement of vibration, an acceleration pickup 8 was mounted on the end surface at a cutting feed direction side, and vibration of the workpiece 9 was detected as a waveform of vibration acceleration and recorded. In the Comparative Example, there was a tendency observed that the peak of waveform of vibration acceleration is increased with increasing the number of pass, whereas in the Example, there was a tendency observed that the peak of waveform is gradually decreased over the vicinity of 40th-pass from 1st-pass, and thereafter becomes constant. Therefore, of the waveforms of from 40th-pass to 50th-pass, a part thereof was analyzed by fast Fourier transform to obtain intensity of vibration acceleration and power of vibration acceleration with respect to eacy frequency in the Example and the Comparative Example, and the results were shown in FIG. 6A and FIG. 6B, respectively.

As shown in FIG. 6A and FIG. 6B, the intensity and power represented in terms of vibration acceleration were small in a high frequency region of about 10,000 Hz or more in the Example as compared with the Comparative Example. That is, the cutting tool holder 1 damp vibration of the cutting tool 3 by using the inner sleeve 40 together with the taper collet 20.

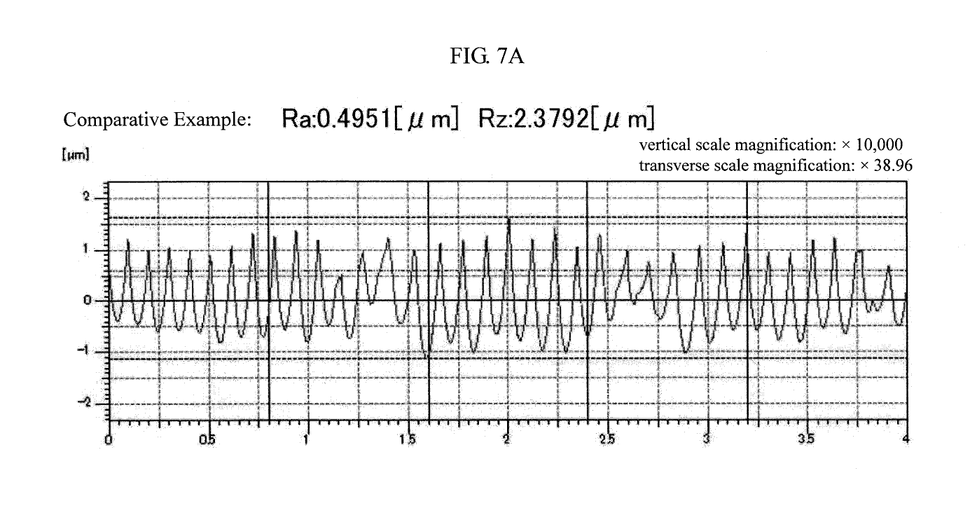

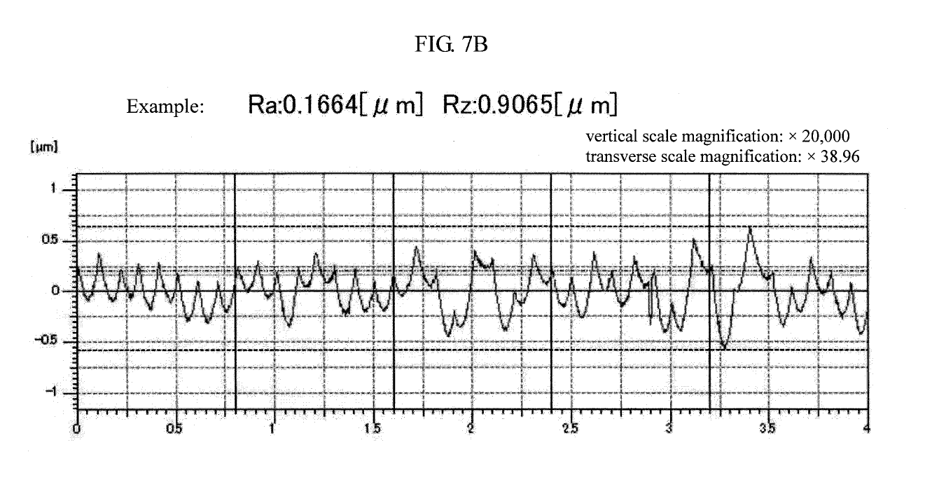

Machining accuracy was evaluated by measuring surface roughness of the cut surface 91 (side surface) of the workpiece 9, which is a surface parallel in a protrusion direction of the end mill after the cutting of 100-pass, that is, in an accumulated cutting feed distance of 16 m. The measurement of surface roughness was performed by measuring arithmetic average roughness (Ra) and ten-point average roughness (Rz) by using a commercially available surface roughness measuring instrument. FIG. 7A and FIG. 7B show the measurement results of the Comparative Example and the Example together with roughness curves, respectively.

As shown in FIG. 7A, the surface roughness in the Comparative Examples was Ra: 0.4951 μm and Rz: 2.3792 μm. On the other hand, as shown in FIG. 7B, the surface roughness in the Example was Ra: 0.1664 μm and Rz: 0.9065 μm. Thus, it can be seen that the surface roughness was improved in the Example as compared with the Comparative Example. That is, machining accuracy can be improved by using the inner sleeve 40 together with the taper collet 20.

As described above, according to the cutting tool holder 1 using the inner sleeve 40, vibration of the cutting tool 3 is dampened in the cutting operation, and as a result, chatter vibration of the cutting tool 3 can be prevented and surface roughness of a workpiece to be cut can be improved, thereby machining accuracy can be improved.

In the Example and Comparative Example, the measurement of abrasion loss (chipping) of a flank face of the cutting tool 3 before and after the cutting operation of 100-pass was performed by observation using a microscope. Specifically, abrasion loss (abrasion area) before and after the cutting operation was calculated based on a micrograph of the flank face of an end cutting edge. As a result, the abrasion loss in the Comparative Example was 3,309 μm². On the other hand, the abrasion loss in the Example was 2,534 μm². That is, according to the cutting tool holder 1 using the inner sleeve 40, vibration of the cutting tool 3 is dampened, and its abrasion loss can be reduced.

Hereinbefore, the representative example of the present invention is described, but the present invention is not necessarily limited thereto. Those skilled in the art may conceive various alternative examples and modification examples, without departing from the sprit or the appended claims of the invention.

The present application is based on Japanese patent application No. 2014-220788 filed on Oct. 29, 2014, which content is incorporated herein by reference.

### DESCRIPTION OF REFERENCE NUMERALS AND SIGNS

1: cutting tool holder

3: cutting tool

10: collet chuck body

20: taper collet

30: nut

40, 50: inner sleeve

What is claimed is:

1. An inner sleeve for a taper collet, which is to be inserted in a taper collet grasping a shank part of a cutting tool, the inner sleeve comprising a cylindrical part containing a damping alloy having a slit provided thereon.

2. The inner sleeve for a taper collet according to claim 1,
wherein the slit comprises a first slit formed from a first end part in a longitudinal direction of the cylindrical part toward a second end part thereof so as not to penetrate therethrough, and a second slit formed from the second end part toward the first end part so as to not penetrate therethrough, and
the first slit and the second slit are alternately provided.

3. The inner sleeve for a taper collet according to claim 2,
wherein each of the first slit and the second slit has a length larger than ½ of the length of the cylindrical part in a longitudinal direction.

4. The inner sleeve for a taper collet according to claim 1,
wherein the slit comprises a third slit penetrating from a first end part in a longitudinal direction of the cylindrical part toward a second end part thereof.

5. The inner sleeve for a taper collet according to claim 1,
further containing a locking section, which is to be engaged with the taper collet, on an end part in a longitudinal direction of the cylindrical part.

6. The inner sleeve for a taper collet according to claim 1,
wherein the taper collet comprises a taper part, and
wherein a ratio of a thickness of the cylindrical part at a central position in a longitudinal direction and a thickness at a central position in a longitudinal direction of the taper part is from 5:95 to 99:1.

7. A cutting tool holder comprising a collet chuck body, the taper collet, and the inner sleeve for a taper collet according to claim 1.
